(19) United States
(12) Patent Application Publication
(10) Pub. No.: US 2020/0117113 A1
(43) Pub. Date: Apr. 16, 2020

(54) PRINT HEAD AND IMAGE FORMING APPARATUS WHICH INCLUDES PRINT HEAD

(71) Applicant: CANON KABUSHIKI KAISHA, Tokyo (JP)

(72) Inventors: Hitoshi Iwai, Abiko-shi (JP); Daisuke Aruga, Abiko-shi (JP); Shinichiro Hosoi, Tokyo (JP); Toshiki Momoka, Tokyo (JP); Takehiro Ishidate, Tokyo (JP)

(21) Appl. No.: 16/596,486

(22) Filed: Oct. 8, 2019

(30) Foreign Application Priority Data
Oct. 15, 2018 (JP) 2018-194551

(51) Int. Cl. G03G 15/04

(52) U.S. Cl. CPC G03G 15/04036

(57) ABSTRACT

In a case where portions pressed by a moving mechanism and positions of positioning pins provided on one end and the other end of a print head in the longitudinal direction do not overlap with each other in a moving direction of the print head, when the print head is pressed by the moving mechanism with the positioning pins abutting against a drum unit, a force is applied to a region between the pressed portions provided at two portions of the print head in a pressing direction so that the print head is deformed. In view of the above, a protruding portion is provided which protrudes from a side wall surface of the print head in a direction perpendicular to both of the longitudinal direction of the print head and a moving direction of the print head, and which extends in the longitudinal direction of the print head.

### BACKGROUND OF DISCLOSURE

### Field of the Disclosure

The disclosure relates to a print head which abuts against a drum unit including a photosensitive drum, thus being positioned with respect to the photosensitive drum, and to an image forming apparatus which includes the print head.

### Description of the Related Art

An image forming apparatus, such as a printer or a copier, includes an optical print head provided with a plurality of light emitting elements for exposing a photosensitive drum. An optical print head is known where LEDs (Light Emitting Diodes), organic EL (Electro Luminescence, or OLED: Organic Light Emitting Diode) or the like are used as light emitting elements, for example, and the plurality of light emitting elements are arranged in one row or in two rows in a staggered manner along a direction of the rotary axis of the photosensitive drum, for example. The optical print head includes a plurality of lenses for causing light emitted from the plurality of light emitting elements to be focused on a photosensitive drum. The plurality of lenses are disposed between the plurality of light emitting elements and the photosensitive drum so as to oppose the front surface of the photosensitive drum along the arrangement direction of the light emitting elements. The light emitted from the plurality of light emitting elements is focused on the front surface of the photosensitive drum through the lenses so that an electrostatic latent image is formed on the photosensitive drum.

The photosensitive drum is a consumable element, therefore the photosensitive drum needs to be periodically replaced. An operator which performs an operation of replacing a photosensitive drum or the like can perform maintenance of an image forming apparatus by replacing a drum unit which includes the photosensitive drum. When the optical print head exposes the photosensitive drum, a distance. between the optical print head and the front surface of the photosensitive drum is extremely small. Accordingly, when an operator, such as a user or a service person, replaces the drum unit, the operator may erroneously cause the drum unit and the photosensitive drum to come into contact with each other. For this reason, an image forming apparatus is known which includes a moving mechanism for moving the optical print head to an exposure position, which is a position for exposing the photosensitive drum, and to a separated position, which is a position separated more from the drum unit than the exposure position.

An image forming apparatus described in Japanese Patent Application Laid-Open No. 2005-335074 includes a pressing unit which causes an optical print head to move with respect to a drum unit so as to adjust a distance between the optical print head and a photosensitive drum. The pressing unit is provided at a position in the vicinity of the center of the optical print head in the longitudinal direction of the optical print head. An operator operates the pressing unit to press a portion in the vicinity of the center of the optical print head, thus moving the optical print head with respect to the drum unit. Further, positioning pins are provided at positions in the vicinity of both ends of the optical print head in the longitudinal direction of the optical print head, and the positioning pins protrude toward the drum unit side for positioning the optical print head with respect to the photosensitive drum. The positioning pins abut against the drum unit, thus forming a gap between the optical print head and the front surface of the photosensitive drum. That is, the optical print head is pressed toward the drum unit by the pressing unit, thus being positioned with respect to the photosensitive drum.

However, the following problems arise when portions which are provided on one end side and the other end side of the optical print head in the longitudinal direction of the optical print head and which are pressed by the moving mechanism (pressed portion) and positions of the positioning pins provided on the one end side and the other end side of the optical print head in the longitudinal direction of the optical print head do not overlap with each other in the moving direction of the optical print head. The pressed portions of the optical print head are pressed by the moving mechanism with the positioning pins abutting against the drum unit and hence, a region between two pressed portions provided on the one end side and the other end side of the optical print head in the longitudinal direction of the optical print head is deformed in a direction along which the optical print head is pressed. With an increase in the amount of deformation of the optical print head at the exposure position, the position of the optical print head with respect to the photosensitive drum is significantly changed, thus becoming a cause of defective exposure. In the case of an optical print head which uses a resin as a material from a viewpoint of reducing costs, the above-mentioned amount of deformation particularly increases.

It may be considered to increase the size of the optical print head per se in order to increase rigidity of the optical print head. However, an increase in the amount of resin used for molding leads to an increase in costs. Accordingly, there is a demand for increasing rigidity of the optical print head while suppressing the amount of resin used for molding.

### SUMMARY OF THE DISCLOSURE

One embodiment of the disclosure is directed to a print head which is provided to an image forming apparatus including a drum unit having a photosensitive drum. The print head includes a circuit board including tight emitting elements which emit tight for exposing the photosensitive drum; a lens array configured to cause the light emitted from the light emitting elements to be focused on the photosensitive drum; and a holder including the circuit board and the lens array, and made of a resin. The holder includes a mounting portion on which the circuit board is mounted; a first pressed portion and a second pressed portion with which a pressing portion comes into contact, the pressing portion pressing the print head toward the drum unit, thus moving the print head toward the drum unit, wherein the first pressed portion is provided to the mounting portion at a position on one side of the mounting portion in a longitudinal direction of the print head, and the second pressed portion is provided to the mounting portion at a position on the other side of the mounting portion in the longitudinal direction; a first positioning portion and a second positioning portion for positioning the print head, which is pressed and moved by the pressing portion, at a position for exposing the photosensitive drum, the first positioning portion being provided to the first pressed portion at a position on an upstream side of the first pressed portion in one direction from the first pressed portion toward the second pressed portion, and abutting against the drum unit, and the second positioning portion being provided to the second pressed portion at a position on a downstream side of the second pressed portion in the one direction, and abutting against the drum unit; a first side wall portion which opposes one side of the circuit board in a perpendicular direction which is perpendicular to both of the longitudinal direction and a moving direction of the print head; a second side wall portion which opposes the other side of the circuit board in the perpendicular direction; and a protruding portion which protrudes from at least either one of a surface of the first side wall portion on a side opposite to a surface of the first side wall portion which opposes the circuit board in the perpendicular direction and a surface of the second side wall portion on a side opposite to a surface of the second side wall portion which opposes the circuit board in the perpendicular direction. The protruding portion extends in the longitudinal direction while straddling a line bisecting the mounting portion in the longitudinal direction.

Another embodiment of the disclosure is also directed to a print head which is provided to an image forming apparatus including a drum unit having a photosensitive drum. The print head includes a circuit board including a light emitting elements which emit light for exposing the photosensitive drum; a lens array configured to cause the light emitted from the light emitting elements to be focused on the photosensitive drum; and a holder including the circuit board and the lens array, and made of a resin. The holder includes a mounting portion on which the circuit board is mounted; a first pressed portion and a second pressed portion with which a pressing portion comes into contact, the pressing portion pressing the print head toward the drum unit, thus moving the print head toward the drum unit, wherein the first pressed portion is provided to the mounting portion at a position on one side of the mounting portion in a longitudinal direction of the print head, and the second pressed portion is provided to the mounting portion at a position on the other side of the mounting portion in the longitudinal direction; a first positioning portion and a second positioning portion for positioning the print head, which is pressed and moved by the pressing portion, at a position for exposing the photosensitive drum, the first positioning portion being provided to the first pressed portion at a position on an upstream side of the first pressed portion in one direction from the first pressed portion toward the second pressed portion, and abutting against the drum unit, and the second positioning portion being provided to the second pressed portion at a position on a downstream side of the second pressed portion in the one direction, and abutting against the drum unit; a first side wall portion which opposes one side of the circuit board in a perpendicular direction which is perpendicular to both of the longitudinal direction and a moving direction of the print head; a second side wall portion which opposes the other side of the circuit board in the perpendicular direction; and a first protruding portion and a second protruding portion which protrude from at least either one of a surface of the first side wall portion on a side opposite to a surface of the first side wall portion which opposes the circuit board in the perpendicular direction and a surface of the second side wall portion on a side opposite to a surface of the second side wall portion which opposes the circuit board in the perpendicular direction. The first protruding portion extends in the longitudinal direction on one end side of the mounting portion in the longitudinal direction, and the second protruding portion extends in the longitudinal direction on the other end side of the mounting portion in the longitudinal direction.

Further features and aspects of the present disclosure will become apparent from the following description of example embodiments with reference to the attached drawings.

### BRIEF DESCRIPTION OF THE DRAWINGS

FIG. 1A is a schematic cross-sectional view of an example image forming apparatus.

FIG. 1B is a schematic cross-sectional view of another example image forming apparatus.

FIG. 2A and FIG. 2B are views for describing the structure of a drum unit and an area around the drum unit.

FIG. 3 is a schematic perspective view of an example exposure unit.

FIG. 4 is a view for describing the structure of an example optical print head.

FIG. 5A, FIG. 5B, FIG. 5C, FIG. 5D and FIG. 5E are views for describing an example circuit board and a lens array which is included in the optical print head.

FIG. 6A, FIG. 6B and FIG. 6C are views for describing an example structure of a mounting portion.

FIG. 7A and FIG. 7B are enlarged perspective views of the front side of a moving mechanism.

FIG. 8A and. FIG. 8B are views for describing an example link mechanism.

FIG. 9A and FIG. 9B are views for describing an example modification of the moving mechanism.

FIG. 10 is a view for describing an example modification of the optical print head.

FIG. 11 is a view for describing example ribs of the optical print head.

FIG. 12 is a graph illustrating the results of calculation for checking the advantageous effects from the ribs suppressing the amount of deformation of the optical print head.

FIG. 13 is a view for describing the ribs formed on both ends of the optical print head.

FIG. 14 is a graph for describing the relationship between the length of the rib and the amount of deformation of the optical print head.

FIG. 15A and FIG. 15B are views for describing an example modification of the rib formed on the optical print head.

### DESCRIPTION OF THE EXAMPLE EMBODIMENTS

Hereinafter, various modes for carrying out the disclosure will be described with reference to the drawings. Unless otherwise specified, sizes, materials, shapes, relative arrangements and the like of the components described below should not be construed as limiting the scope of the disclosure.

### Example Image Forming Apparatus

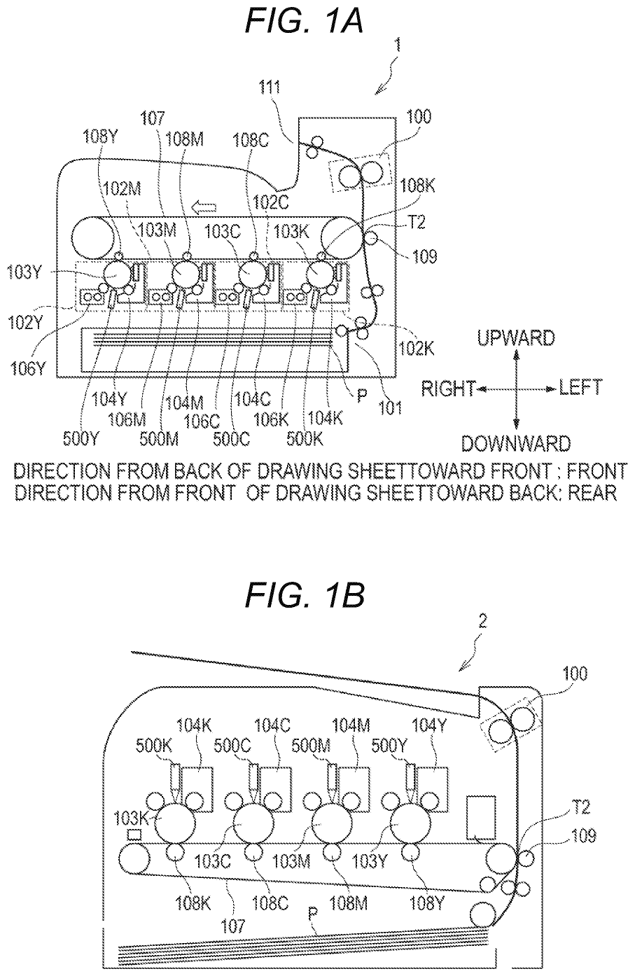

First, the schematic configuration of an image forming apparatus 1 will be described. FIG. 1A is a schematic cross-sectional view of the image forming apparatus 1. The image forming apparatus 1 illustrated in FIG. 1A is a color printer (SFP: Single Function Printer) which does not include a reader. However, the image forming apparatus may be a copier which includes a reader. Further, the image forming apparatus is not limited to a color image forming apparatus which includes a plurality of photosensitive drums 103 illustrated in FIG. 1A. The image forming apparatus may be a color image forming apparatus which includes one photosensitive drum 103, or may be an image forming apparatus which forms a monochrome image.

The image forming apparatus 1 illustrated in FIG. 1A includes four image forming units 102Y, 102M, 102C and 102K (hereinafter also collectively referred to as simply “image forming unit 102”) which form toner images of respective colors of yellow, magenta, cyan and black. The image forming units 102Y, 102M, 102C and 102K respectively include photosensitive drums 103Y, 103M, 103C and 103K (hereinafter also collectively referred to as simply “photosensitive drum 103”). The image forming units 102Y, 102M, 102C and 102K include chargers 104Y, 104M, 104C and 104K (hereinafter also collectively referred to as simply “charger 104”) which respectively cause the photosensitive drums 103Y, 103M, 103C and 103K to be charged. The image forming units 102Y, 102M, 102C and 102K respectively include LED (Light Emitting Diode, hereinafter described as “LED”) exposure units 500Y, 500M, 500C and 500K (hereinafter also collectively referred to as simply “exposure unit 500”) as exposure light sources which emit light for exposing the photosensitive drums 103Y, 103M, 103C and 103K. The image forming units 102Y, 102M, 102C and 102K further includes developing devices 106Y, 106M, 106C and 106K (hereinafter also collectively referred to as simply “developing device 106”) as developing units which develop electrostatic latent images on the photosensitive drum 103 using toner, thus developing the toner images of the respective colors on the photosensitive drum 103. Letters “Y”, “M”, “C” and “K” given to reference characters indicate colors of toner.

The image forming apparatus 1 illustrated in FIG. 1A is an image forming apparatus which adopts a so-called. “lower surface exposure system” where the photosensitive drum 103 is exposed from the downward direction. Hereinafter, the description is made on the premise that the image forming apparatus adopts the lower surface exposure system. However, the image forming apparatus may be an image forming apparatus which adopts an “upper surface exposure system” where the photosensitive drum 103 is exposed from the upward direction as in the case of an image forming apparatus 2 illustrated in FIG. 1B. In FIG. 1B, constitutional elements substantially equal to the constitutional elements illustrated in FIG. 1A are given the same reference characteristics.

The image forming apparatus 1 includes an intermediate transfer belt 107 and primary transfer rollers 108 (Y, M, C, K). Toner images formed on the photosensitive drum 103 are transferred to the intermediate transfer belt 107. The primary transfer rollers 108 (Y, M, C, K) cause the toner images formed on the photosensitive drum 103 to be sequentially transferred to the intermediate transfer belt. The image forming apparatus 1 also includes a secondary transfer roller 109 and a fixing unit 100. The secondary transfer roller 109 functions as a transfer unit which causes the toner images on the intermediate transfer belt 107 to be transferred to a recording paper sheet P (one example of a recording medium) conveyed from a feeding unit 101. The fixing unit 100 causes the secondarily transferred images to be fixed on the recording paper sheet P.

### Image Forming Process

The exposure unit 500Y exposes the front surface of the photosensitive drum 103Y charged by the charger 104Y. With such an operation, an electrostatic latent image is formed on the photosensitive drum 103Y. Next, the developing device 106Y develops the electrostatic latent image formed on the photosensitive drum 103Y by yellow toner. The yellow toner image developed on the front surface of the photosensitive drum 103Y is transferred onto the intermediate transfer belt 107 by the primary transfer roller 108Y. A magenta toner image, a cyan toner image and a black toner image are also transferred to the intermediate transfer belt 107 by a similar image forming process.

The toner images of the respective colors transferred onto the intermediate transfer belt 107 are conveyed to a secondary transfer unit T2 by the intermediate transfer belt 107. A transfer bias for transferring a toner image to a recording paper sheet P is applied to the secondary transfer roller 109 disposed at the secondary transfer unit T2. The toner images conveyed to the secondary transfer unit T2 are transferred to the recording paper sheet P, conveyed from the feeding unit 101, by the transfer bias of the secondary transfer roller 109. The recording paper sheet P to which the toner images are transferred is conveyed to the fixing unit 100. The fixing unit 100 fixes the toner images to the recording paper sheet P by heat and pressure. The recording paper sheet P on which fixing treatment is performed by the fixing unit 100 is discharged to a discharge portion 111.

### Example Drum Unit and Developing Unit

The image forming apparatus 1 includes drum units 518Y, 518M, 518C and 518K (hereinafter also collectively referred to as simply “drum unit 518”) each of which includes the photosensitive drum 103. The drum unit 518 is a cartridge which is replaced by an operator, such as a user or a person who performs maintenance. The drum unit 518 supports the photosensitive drum 103 in a rotatable manner. Specifically, the photosensitive drum 103 is supported on the frame of the drum unit 518 in a rotatable manner. It is also possible to adopt a configuration where the drum unit 518 does not include the charger 104 and a cleaning apparatus.

The image forming apparatus 1 of this embodiment also includes developing units 641Y, 641M, 641C and 641K (hereinafter also collectively referred to as simply “developing unit 641”) which are provided separately from the drum unit 518. The developing unit 641 in this embodiment is a cartridge where the developing device 106 illustrated in FIG. 1A and a toner accommodating portion are formed into an integral body. The developing device 106 includes a developing sleeve (not illustrated in the drawing) which carries a developer. The developing unit 641 is provided with a plurality of gears which rotates a screw for agitating toner and carrier. When these gears are deteriorated over time, an operator removes the developing unit 641 from the apparatus body of the image forming apparatus 1 so as to replace the developing unit 641. The drum unit 518 and the developing unit 641 may be formed of a process cartridge where the drum unit 518 and the developing unit 641 are formed into an integral body.

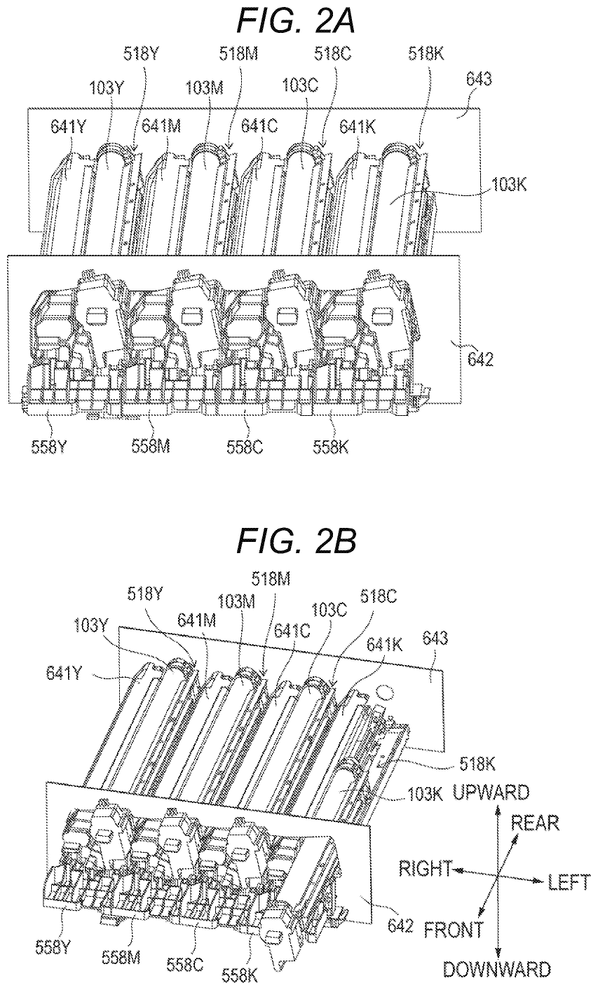

FIG. 2A is a perspective view illustrating the schematic structure around the drum unit 518, which the image forming apparatus 1 includes, and the schematic structure around the developing unit 641. FIG. 2B is a view illustrating a state where the drum unit 518 is inserted into the image forming apparatus 1 from the outside of the apparatus body.

As illustrated in FIG. 2A, the image forming apparatus 1 includes a front plate 642, formed of a sheet metal, and a rear plate 643 formed of a sheet metal in the same manner. The front plate 642 is a side wall provided on the near side of the image forming apparatus L The front plate 642 forms a portion of the housing of the apparatus body on the near side of the body of the image forming apparatus 1. The rear plate 643 is a side watt provided on the rear side of the image forming apparatus 1. The rear plate 643 forms a portion of the housing of the apparatus body on the far side of the body of the image forming apparatus 1. As illustrated in FIG. 2A, the front plate 642 and the rear plate 643 are disposed so as to oppose each other, and a sheet metal (not illustrated in the drawing), which functions as a beam, is caused to extend between the front plate 642 and the rear plate 643. Each of the front plate 642, the rear plate 643 and the beam (not illustrated in the drawing) forms a portion of the frame of the image forming apparatus 1.

With respect to the image forming apparatus 1 of this embodiment and constitutional members of the image forming apparatus 1, the terms “the front surface side” or “the near side” refer to the side where the drum unit 518 is removed from or inserted into the apparatus body. The terms “the front surface side” or “the near side” also refer to the side where a user stands with respect to the image forming apparatus when the user operates the image forming apparatus 1. The terms “the back surface side” or “the far side” refer to the side on the side opposite to the front surface side or the near side.

An opening is formed in the from plate 642 so as to allow removal and insertion of the drum unit 518 and the developing unit 641 from the near side of the image forming apparatus 1. The drum unit 518 and the developing unit 641 are mounted at a predetermined position (mounted position) in the body of the image forming apparatus 1 via the opening. The image forming apparatus 1 includes covers 558Y, 558M, 558C and 558K (hereinafter also collectively referred to as simply “cover 558”) which cover the near side of both the drum unit 518 and the developing unit 641 mounted at the mounted position. One end of the cover 558 is fixed to the body of the image forming apparatus 1 by a hinge so that the cover 558 is pivotable with respect to the body of the image forming apparatus 1 by the hinge. An operator opens the cover 558 to remove the drum unit 518 or the developing unit 641 in the body. Then, the operator inserts a new drum unit 518 or developing unit 641, and closes the cover 558. With such operations, the replacement operation is completed.

As illustrated in FIG. 2A and FIG. 2B, in the description made hereinafter, the front plate 642 side of the apparatus body is defined as a front side (a near side or a front surface side), and the rear plate 643 side of the apparatus body is defined as a rear side (a far side or a back surface side). Using the photosensitive drum 103K, on which an electrostatic latent image relating to a black toner image is formed, as the reference, the side where the photosensitive drum 103Y is disposed, on which an electrostatic latent image relating to a yellow toner image is formed, is defined as a right side. Using the photosensitive drum 103Y, on which an electrostatic latent image relating to a yellow toner image is formed, as the reference, the side where the photosensitive drum 103K is disposed, on which an electrostatic latent image relating to a black toner image is formed, is defined as a left side. Further, a direction which is perpendicular to the front-rear direction and the left-right direction defined in this embodiment, and which extends toward the upper side in the vertical direction is defined as an upward direction. A direction which is perpendicular to the front-rear direction and the left-right direction defined in this embodiment, and which extends toward the lower side in the vertical direction is defined as a downward direction, The defined frontward direction, rearward direction, rightward direction, leftward direction, upward direction and downward direction are illustrated in FIG. 2B. Further, a direction of the rotary axis of the photosensitive drum 103 which will be described below is a direction which is aligned with the front-rear direction illustrated in FIG. 2B. The longitudinal direction of an optical print head 105 is also a direction which is aligned with the front-rear direction illustrated in FIG. 2B, That is, the direction of the rotary axis of the photosensitive drum 103 and the longitudinal direction of the optical print head 105 are directions which are aligned with each other.

### Example Exposure Unit

Next, the exposure unit 500 which includes the optical print head 105 will be described. The optical print head 105 has a longitudinal shape which extends in the direction of the rotary axis of the photosensitive drum 103. An electrophotographic image forming apparatus adopts an exposure system, for example, a laser beam scanning exposure system where an irradiation beam from a semiconductor laser is made to scan by a rotatable polygon mirror or the like, thus exposing a photosensitive drum through an f-O lens or the like. The “optical print head 105” described in this embodiment is used in an LED exposure system where the photosensitive drum 103 is exposed using light emitting elements, such as LEDs, which are arranged along the direction of the rotary axis of the photosensitive drum 103. The “optical print head 105” is not used for the above-described laser beam scanning exposure system.

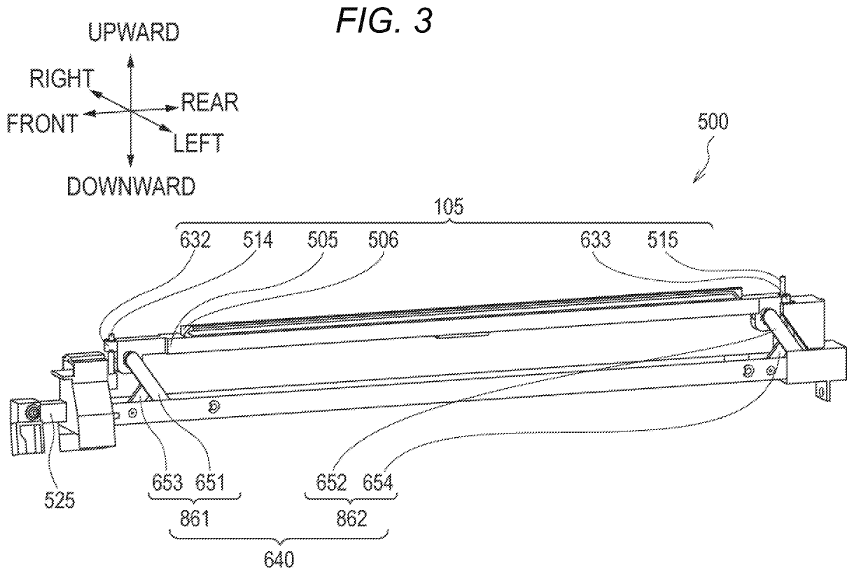

The exposure unit 500 described in this embodiment is provided at a position below the rotary axis of the photosensitive drum 103 in the vertical direction, and LEDs 503 which the optical print head 105 includes expose the photosensitive drum 103 from below. However, it may be possible to adopt the configuration where the exposure unit 500 is provided at a position above the rotary axis of the photosensitive drum 103 in the vertical direction, and exposes the photosensitive drum 103 from above (see FIG. 1B). FIG. 3 is a schematic perspective view of the exposure unit 500 which the image forming apparatus 1 of this embodiment includes.

As can be understood from FIG. 3, the exposure unit 500 includes the optical print head 105 and a moving mechanism 640. The optical print head 105 includes a lens array 506, a circuit board 502 (not illustrated in FIG. 3), a holder 505, an abutment pin 514, and an abutment pin 515.

The abutment pin 514 and the abutment pin 515 abut against the drum unit 518, thus forming a gap between the lens array 506 and the photosensitive drum 103, and the optical print head 105 is positioned with respect to the photosensitive drum 103 for forming an image. The moving mechanism 640 includes a first link mechanism 861, a second link mechanism 862, and a sliding portion 525. The first link mechanism 861 includes a link member 651 and a link member 653. The second link mechanism 862 includes a link member 652 and a link member 654. With the opening/closing action of the cover 558 (not illustrated in FIG. 3), the sliding portion 525 slidably moves in the front-rear direction. The first link mechanism 861 and the second link mechanism 862 are driven in conjunction with the slidable movement of the sliding portion 525 so that the optical print head 105 moves upward and downward. The action of the moving mechanism 640 will be described later in detail. Fitting holes are formed in portions of the frame of the drum unit 518 against which the abutment pin 514 (and the abutment pin 515) abuts. The distal end of the abutment pin 514 (and the abutment pin 515) is fitted in the fitting hole by approximately 5 mm, for example. With such a configuration, the optical print head 105 is accurately positioned with respect to the photosensitive drum 103.

In this embodiment, the exposure unit 500 is provided at a position below the rotary axis of the photosensitive drum 103 in the vertical direction. That is, the image forming apparatus 1 of this embodiment is an image forming apparatus which adopts a so-called. “lower surface exposure” system where the LEDs 503 expose the photosensitive drum 103 from below. The exposure unit 500 may be provided at a position above the rotary axis of the photosensitive drum 103 in the vertical direction. Such a configuration for an exposure system is referred to as a so-called “upper surface exposure” system having a configuration where the LEDs 503 expose the photosensitive drum 103 from above.

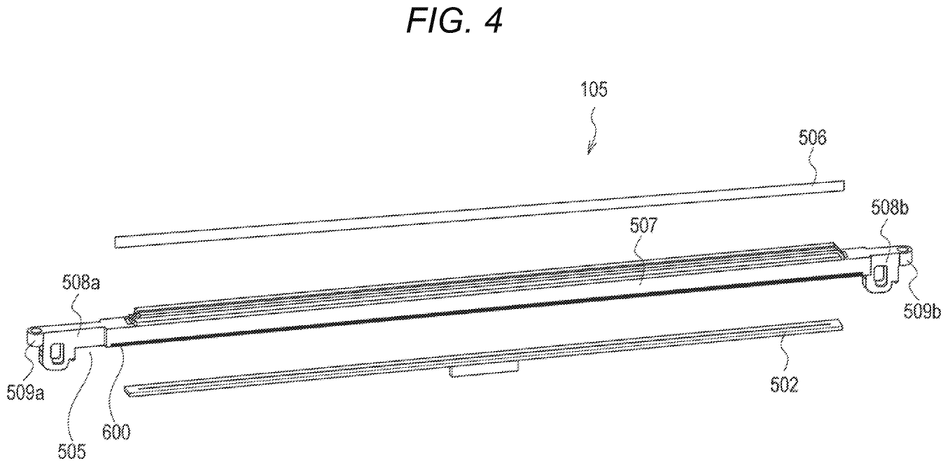

Next, the structure of the optical print head 105 will be described. FIG. 4 is a view for describing the structure of the optical print head 105. As illustrated in FIG. 4, the optical print head 105 includes the circuit board 502, the lens array 506 and the holder 505. The structure of the lens array 506 and the structure of the circuit board 502 will be described later in detail. The holder 505 is a holder which holds the circuit board 502 and the lens array 506. In this embodiment, a resin is adopted as a material for forming the holder 505 from a viewpoint of reducing the weight of the optical print head 105 per se and reducing costs.

The holder 505 includes a mounting portion 507, a first pressed portion 508a, a second pressed portion 508b, a first mounting portion 509a and a second mounting portion 509b. All of these members are formed as an integral body made of a resin.

The mounting portion 507 of the holder holds the circuit board 502. The mounting portion 507 is a housing in which a lower side is open. The circuit board 502 is inserted through this opening, and the circuit board 502 is caused to adhere to the mounting portion 507 by an adhesive agent. With such a configuration, the circuit board 502 is held by the mounting portion 507.

The first pressed portion 508a is provided on one end side of the mounting portion 507 in the longitudinal direction of the mounting portion 507. In other words, the first pressed portion 508a is integrally formed with the mounting portion 507 such that the first pressed portion 508a is positioned on the near side (one side) of the mounting portion 507. The first pressed portion 508a forms a portion of the holder 505. The second pressed portion 508b is provided on the other end side of the mounting portion 507 in the longitudinal direction of the mounting portion 507. In other words, the second pressed portion 508b is integrally formed with the mounting portion 507 such that the second pressed portion 508b is positioned on the far side (the other side) of the mounting portion 507. The second pressed portion 508b forms a portion of the holder 505. That is, assuming that a direction from the first pressed portion 508a toward. the second pressed portion 508b is defined as one direction, the mounting portion 507, the first pressed portion 508a and the second pressed portion 508b are integrally formed with each other such that the mounting portion 507 is positioned between the first pressed portion 508a and the second pressed portion 508b.

The first pressed portion 508a is a portion to be pressed by the link member 651 described later. The second pressed portion 508b is a portion to be pressed by the link member 652 described later. The link member 651 presses the first pressed portion 508a toward the drum unit 518, and the link member 652 presses the second pressed portion 508b toward the drum unit 518. Accordingly, the optical print head 105 moves in a direction approaching the drum unit 518 from a position where the optical print head 105 is away from the drum unit 518.

The first mounting portion 509a is provided on one end side of the first pressed portion 508a in the longitudinal direction of the optical print head 105. In other words, the first mounting portion 509a is integrally formed with the first pressed portion 508a such that the first mounting portion 509a is positioned on the near side of the first pressed portion 508a. The first mounting portion 509a forms a portion of the holder 505. The second mounting portion 509b is provided on the other end side of the second pressed portion 508b in the longitudinal direction of the optical print head 105. In other words, the second mounting portion 509b is integrally formed with the second pressed portion 508b such that the second mounting portion 509b is positioned on the far side of the second pressed portion 508b. The second mounting portion 509b forms a portion of the holder 505. That is, the mounting portion 507, the first pressed portion 508a and the first mounting portion 509a are integrally formed with each other such that the first pressed portion 508a is positioned between the first mounting portion 509a and the mounting portion 507. In the same manner, the mounting portion 507, the second pressed portion 508b and the second mounting portion 509b are integrally formed with each other such that the second pressed portion 508b is positioned between the second mounting portion 509b and the mounting portion 507.

The abutment pin 514 (not illustrated in FIG. 4) is mounted on the first mounting portion 509a. The first mounting portion 509a and the abutment pin 514 (not illustrated in FIG. 4) are also collectively referred to as “first positioning portion”. Assume that a direction from the first pressed portion 508a toward the second pressed portion 508b is defined as one direction. In such a case, the first positioning portion is provided on the upstream side of the first pressed portion 508a in one direction. In this embodiment, the first positioning portion is integrally formed with the first pressed portion 508a. However, a configuration may be adopted where the first positioning portion and the first pressed portion 508a are separate bodies and are fixed to each other. The abutment pin 515 (not illustrated in FIG. 4) is mounted on the second mounting portion 509b. The second mounting portion 509b and the abutment pin 515 (not illustrated in FIG. 4) are also collectively referred to as “second positioning portion”. The second positioning portion is provided on the downstream side of the second pressed portion 508b in the one direction. In this embodiment, the second positioning portion is integrally formed with the second pressed portion 508b. However, a configuration may be adopted where the second positioning portion and the second pressed portion 508b are separate bodies, and are fixed to each other. Although the description will be made in detail later, the abutment pin 514 protrudes from the first mounting portion 509a toward the drum unit 518, and the abutment pin 515 protrudes from the second mounting portion 509b toward the drum unit 518. The link member 651 and the link member 652 press the optical print head 105 toward the drum unit 518 so that the optical print head 105 moves and, as a result, the abutment pin 514 and the abutment pin 515 abut against the drum unit 5180 With such abutment, a gap is formed between the lens array 506 and the photosensitive drum 103.

It is not always necessary that the first mounting portion 509a and the abutment pin 514 are separate members. The first mounting portion 509a and the abutment pin 514 may be formed as an integral member. For example, a protrusion protruding from the first mounting portion 509a toward the drum unit 518 may be formed on the first mounting portion 509a. With such a configuration, it is possible to allow this protrusion to have a function similar to that of the abutment pin 514. Further, instead of the abutment pin 514 or the protrusion, the first mounting portion 509a per se may be caused to protrude toward the drum unit 518 beyond the tens array 506. That is, the surface of the first mounting portion 509a on the drum unit 518 side abuts against the drum unit 518 so that the optical print head 105 is positioned with respect to the photosensitive drum 103. In this case, the first mounting portion 509a per se functions as the first positioning portion.

In the same manner, it is not always necessary that the second mounting portion 509b and the abutment pin 515 are separate members. The second mounting portion 509b and the abutment pin 515 may be formed as an integral member. For example, a protrusion protruding from the second mounting portion 509b toward the drum unit 518 may be formed on the second mounting portion 509b. With such a configuration, it is possible to allow this protrusion to have a function similar to that of the abutment pin 515. Further, instead of the abutment pin 515 or the protrusion, the second mounting portion 509b per se may be caused to protrude toward the drum unit 518 beyond the lens array 506. That is, the surface of the second mounting portion 509b on the drum unit 518 side abuts against the drum unit 518 so that the optical print head 105 is positioned with respect to the photosensitive drum 103. In this case, the second mounting portion 509b per se functions as the second positioning portion.

In this embodiment, the first mounting portion 509a is provided to the first pressed portion 508a on a side opposite to the side where the mounting portion 507 is provided. The second mounting portion 509b is provided to the second pressed portion 508b on a side opposite to the side where the mounting portion 507 is provided. That is, from the rear side to the front side of the optical print head 105, the second mounting portion 509b, the second pressed portion 508b, the mounting portion 507, the first pressed portion 508a, and the first mounting portion 509a are arranged in this order. However, the positional relationship between the first mounting portion 509a and the first pressed portion 508a may be opposite, and the positional relationship between the second mounting portion 509b and the second pressed portion 508b may be opposite. That is, from the rear side to the front side of the optical print head 105, the second pressed portion 508b, the second mounting portion 509b, the mounting portion 507, the first mounting portion 509a, and the first pressed portion 508a may be arranged in this order. In the case of such a configuration, the abutment pin 514 and the abutment pin 515, which abut against the drum unit 518, are positioned between a portion where the link member 651 presses the first pressed portion 508a and a portion where the link member 652 presses the second pressed portion 508b.

Further, a rib 600 (one example of a protruding portion) is formed on the mounting portion 507, and the rib 600 extends along the longitudinal direction of the optical print head 105. The rib 600 is a protrusion protruding from the mounting portion 507, and plays a role of increasing rigidity of the holder 505. Increasing the size of the holder 505 per se increases the rigidity of the holder 505. However, the developing device 106 and the charger 104 are disposed around the photosensitive drum 103 and hence, the increase in size of the holder 505 per se may cause the holder 505 to come into contact with the developing device 106 and the charger 104. Further, an increase in size of the holder 505 requires increasing the amount of resin used for molding. Accordingly, an increase in the size of the holder 505 is one cause of an increase in costs.

In FIG. 4, the rib 600 may be provided to only the surface of the mounting portion 507 on one side or may be provided to only the surface of the mounting portion 507 on the other side in a perpendicular direction which is perpendicular to both of the longitudinal direction of the optical print head 105 and the moving direction of the optical print head 105 along which the optical print head 105 is moved by the moving mechanism 640. As a matter of course, the rib 600 may be provided to both of the surface of the mounting portion 507 on one side and the surface of the mounting portion 507 on the other side in the perpendicular direction which is perpendicular to both of the longitudinal direction of the optical print head 105 and the moving direction of the optical print head 105 along which the optical print head 105 is moved by the moving mechanism 640.

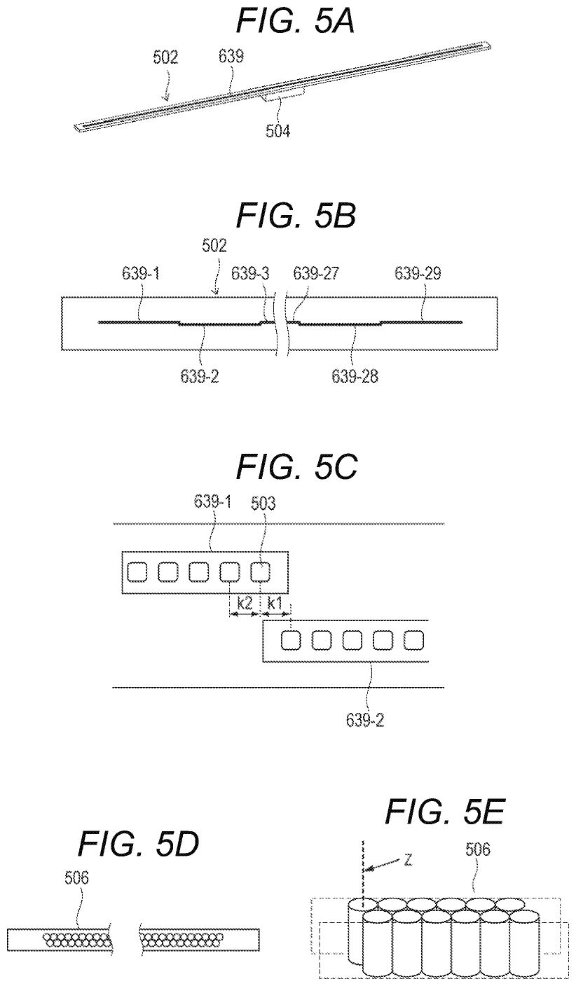

Next, the circuit board 502 will be described. FIG. 5A is a schematic perspective view of the circuit board 502. FIG. 5B illustrates the arrangement of the plurality of LEDs 503 provided to the circuit board 502, and FIG. 5C is an enlarged view of FIG. SB.

LED chips 639 are mounted on the circuit board 502. As illustrated in FIG. 5A, the LED chips 639 are provided to one surface of the circuit board 502, and a connector 504 is provided to the back surface of the circuit board 502. The circuit board 502 is provided with wiring for supplying signals to the respective LED chips 639. One end of a flexible flat cable (FFC) (not illustrated in the drawing) is connected to the connector 504. A circuit board is provided to the body of the image forming apparatus 1. The circuit board 502 includes a control unit and a connector. The other end of the FFC is connected to the connector. A control signal is input into the circuit board 502 from the control unit of the body of the image forming apparatus 1 through the FFC and the connector 504. The LED chip 639 is driven by the control signal input into the circuit board 502.

The LED chips 639 mounted on the circuit board 502 will be described in more detail, As illustrated in FIG. 5B and FIG, 5C, the plurality of LED chips 639-1 to 639-29 (29 pieces) are arranged on one surface of the circuit board 502. A plurality of LEDs 503 are arranged on each of the LED chips 639-1 to 639-29. Each of the LED chips 639-1 to 639-29 includes 516 pieces of LEDs (light emitting elements) which are arranged in one row along the longitudinal direction of the LED chip. A distance k2 between the centers of LEDs disposed adjacent to each other in the longitudinal direction of the LED chip 639 corresponds to resolution of the image forming apparatus 1. Resolution of the image forming apparatus 1 of this embodiment is 1200 dpi and hence, LEDs are arranged in one row in the longitudinal direction of the LED chips 639-1 to 639-29 such that the distance between the centers of LEDs disposed adjacent to each other is 21.16 μm. Accordingly, the exposure range of the optical print head 105 in this embodiment is approximately 316 mm. The photosensitive layer of the photosensitive drum 103 is formed with a width of 316 mm or more. The length of the long side of an A4-size recording paper sheet and the length of the short side of an A3-size recording paper sheet are both 297 mm, Accordingly, the optical print head 105 in this embodiment has an exposure range which allows an image to be formed on either one of the A4-size recording paper sheet and the A3-size recording paper sheet.

The LED chips 639-1 to 639-29 are alternately disposed so as to form two rows along the direction of the rotary axis of the photosensitive drum 103. That is, as illustrated in FIG. 5B, the odd numbered LED chips 639-1, 639-3, 639-29 counted from the left side are mounted in one row in the longitudinal direction of the circuit board 502, and the even numbered LED chips 639-2, 639-4, . . . 639-28 are mounted in one row in the longitudinal direction of the circuit board 502. By arranging the LED chips 639 as described above, as illustrated in FIG. 5C, it is possible to make a distance k1 equal to the distance k2 in the longitudinal direction of the LED chip 639. The distance k1 is a distance between the center of an LED disposed at one end of one of the LED chips 639 disposed adjacent to each other and the center of an LED disposed at the other end of the other of the LED chips 639 disposed adjacent to each other. The distance k2 is a distance between the centers of LEDs disposed adjacent to each other on one LED chip 639.

This embodiment exemplifies a configuration which uses LEDs as an exposure light source. However, an organic EL (Organic Electro Luminescence) may be used as the exposure light source.

Next, the lens array 506 will be described. FIG. 5D is a schematic view of the lens array 506 as viewed from the photosensitive drum 103 side. FIG. 5E is a schematic perspective view of the lens array 506. As illustrated in FIG. 5D, the plurality of lenses are arranged in two rows along the arrangement direction of the plurality of LEDs 503. The lenses are alternately arranged such that one lens in one row is disposed so as to come into contact with both lenses in the other row which are disposed adjacent to each other in the arrangement direction of the lenses. Each lens is a columnar rod lens made of glass. The lens has a light incident surface on which light emitted from the LED 503 is incident, and a light emitting surface from which the light which is incident from the light incident surface is emitted. The material for forming the lens is not limited to glass, and may be a plastic material. The shape of the lens is not also limited to a columnar shape, and may be a polygonal prism, such as a hexagonal prism.

A dotted line Z illustrated in FIG. SE indicates the optical axis of a lens. The optical print head 105 is moved by the above-mentioned moving mechanism 640 in a direction substantially along the optical axis of the lens indicated by the dotted line Z. The optical axis of a lens in this embodiment means a line which connects the center of the light emitting surface of the lens and the focal point of the lens. The lens array 506 has a role of causing light emitted from the LED S03 to be focused on the front surface of the photosensitive drum 101

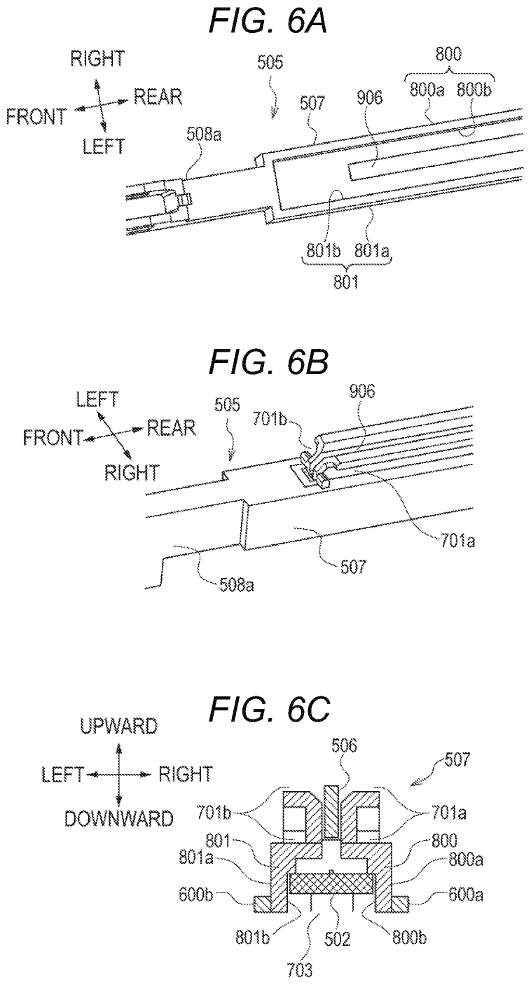

FIG. 6A is a view of the front side of the holder 505 as viewed from below.

The circuit board 502 and the lens array 506 are not illustrated in the drawing. The rib 600 is not illustrated in the drawing either. As illustrated in FIG. 6A, the holder 505 has a through hole 906 which extends along the longitudinal direction of the holder 505. The holder 505 and the lens array 506 are fixed to each other by an adhesive agent in a state where the lens array 506 is fitted in the through hole 906.

As illustrated in FIG. 6A, the mounting portion 507 includes a first side wall portion 800 and a second side wall portion 801. A side wall surface 800b of the first side wall portion 800 is a surface which opposes the circuit board 502 (not illustrated in FIG. 6A). In the same manner, a side wall surface 801b of the second side wall portion 801 is also a surface which opposes the circuit board 502 (not illustrated in FIG. 6A). In a state where the circuit board 502 is not disposed, the side wall surface 800b and the side wall surface 801b are disposed in an opposed manner.

FIG. 6B is a schematic perspective view of the front side of the holder 505. As illustrated in FIG. 6B, a lens mounting portion 701a and a lens mounting portion 701b are formed on the upper portion of the mounting portion 507 of the holder 505. Further, as described above, the upper portion of the mounting portion 507 has the through hole 906. The lens mounting portion 701a and the lens mounting portion 701b are disposed such that the lens mounting portion 701a and the tens mounting portion 701b oppose each other with the through hole 906 therebetween. The tens array 506 is inserted between the lens mounting portion 701a and the tens mounting portion 701b, and the lens array 506 is fixed to the tens mounting portion 701a and the tens mounting portion 701b by an adhesive agent.

FIG. 6C is a cross-sectional view of the mounting portion 507 of the holder 505 taken along a plane perpendicular to the longitudinal direction of the optical print head 105. As illustrated in FIG. 6C, the mounting portion 507 includes the first side wall portion 800 and the second side wall portion 801, and the circuit board 502 is disposed between the first side wall portion 800 and the second side wall portion 801. An opening 703 is formed on the lower side of the holder 505. The circuit board 502 is inserted into a space in the holder 505 through the opening 703, and is caused to adhere to the side wall surface 800b of the first side wall portion 800 and the side wall surface 801b of the second side wall portion 801.

The side wall surface 800b of the first side wall portion 800 and the circuit board 502 oppose each other in a perpendicular direction which is perpendicular to both of the moving direction of the optical print head 105 and the longitudinal direction of the optical print head (the direction of the rotary axis of the photosensitive drum 103). In other words, the side wall surface 800b and the circuit board 502 oppose each other in a left-right direction.

In the same manner, the side wall surface 801b of the second side wall portion 801 and the circuit board 502 oppose each other in a perpendicular direction which is perpendicular to both of the moving direction of the optical print head 105 and the longitudinal direction of the optical print head (the direction of the rotary axis of the photosensitive drum 103). In other words, the side wall surface 801b and the circuit board 502 oppose each other in a left-right direction.

A rib 600a is formed on the surface (side wall surface 800a) of the first side wall portion 800 on a side opposite to the surface (the side wall surface 800b) of the first side wall portion 800 which opposes the circuit board 502. The rib 600a is a protrusion protruding from the side wall surface 800a toward the left side in FIG. 6C. The rib 600a protrudes from the lower end portion of the side wall surface 800a toward the left side. With the formation of the rib 600a at the lower end portion of the side wall portion 800, rigidity of the mounting portion 507 can be further increased. Accordingly, it is desirable to form the rib 600a at a position on the side wall portion 800 as close to the opening 703 as possible. In this embodiment, the thickness (width) of the rib 600a in the left-right direction is equal to the thickness of the first side wall portion 800 in the left-right direction, that is, 1.5 mm. However, the thickness (width) of the rib 600a in the left-right direction is not necessarily equal to the thickness of the first side wall portion 800 in the left-right direction. It is sufficient that the thickness (width) of the rib 600a in the left-right direction is equal to or more than half of the thickness (width) of the first side wall portion 800 in the left-right direction.

In the same manner, a rib 600b is formed on the surface (side wall surface 801a) of the second side wall portion 801 on a side opposite to the surface (side wall surface 801b) of the second side wall portion 801 which opposes the circuit board 502. The rib 600b is a protrusion protruding from the side wall surface 801a toward the right side in FIG. 6C. The rib 600b protrudes from the lower end portion of the side wall surface 801a toward the right side. With the formation of the rib 600b at the lower end portion of the side wall portion 800, rigidity of the mounting portion 507 can be further increased. Accordingly, it is desirable to form the rib 600b at a position on the side wall portion 800 close to the opening 703 as much as possible. In this embodiment, the width of the rib 600b in the left-right direction is equal to the width of the second side wall portion 801 in the left-right direction, that is, 1.5 mm. However, the width of the rib 600b in the left-right direction is not necessarily equal to the width of the second side wall portion 801 in the left-right direction. It is sufficient that the width of the rib 600b in the left-right direction is equal to or more than half of the thickness of the second side wall portion 801 in the left-right direction.

To effectively increase rigidity of the mounting portion 507, as in the case of this embodiment, it is desirable to cause the ribs 600 to protrude from both of the surface (the side wall surface 800a) on one side and the surface (the side wall surface 801a) on the other side of the mounting portion 507 in a direction perpendicular to both of the moving direction of the optical print head 105 along which the optical print head 105 is moved by the moving mechanism 640 and the longitudinal direction of the optical print head 105. However, it is also possible to adopt a configuration where the rib 600a is not formed on the side wall surface 800a, but only the rib 600b is formed on the side wall surface 801a. In the same manner, it is also possible to adopt a configuration where the rib 600b is not formed on the side wall surface 801a, but only the rib 600a is formed on the side wall surface 800a. As described above, it is also possible to adopt a configuration where the rib 600 is formed only on the surface on one side, that is, on either one of the side wall surface 800a or the side wall surface 801a. In the case of such a configuration, rigidity of the mounting portion 507 is lower than rigidity of the mounting portion 507 where the ribs 600 are formed on both of the side wall surface 800a and the side wall surface 801a. However, rigidity of the mounting portion 507 having such a configuration is still higher than rigidity of the mounting portion 507 having no rib 600.

### Example Moving Mechanism

Next, the moving mechanism 640 which moves the optical print head 105 to an exposure position and a retracted position will be described. As described below, the moving mechanism 640 causes the optical print head 105 to reciprocally move between the exposure position and the retracted position. In this embodiment, the exposure position refers to a position where the optical print head 105 is positioned with respect to the drum unit 518 so as to expose the photosensitive drum 103. The retracted position refers to a position where the optical print head 105 is retracted from the drum unit 518 compared to the exposure position in order to allow an operator, such as a user or a service person, to replace the drum unit 518.

As illustrated in FIG. 3, the moving mechanism 640 includes the first link mechanism 861, the second link mechanism 862, the sliding portion 525, and a first support portion 526. The first link mechanism 861 includes the link member 651 and the link member 653. The second link mechanism 862 includes the link member 652 and the link member 654. As illustrated in FIG. 3, the link member 651 and the link member 653 form a λ-type link mechanism, and the link member 652 and the link member 654 form a λ-type link mechanism

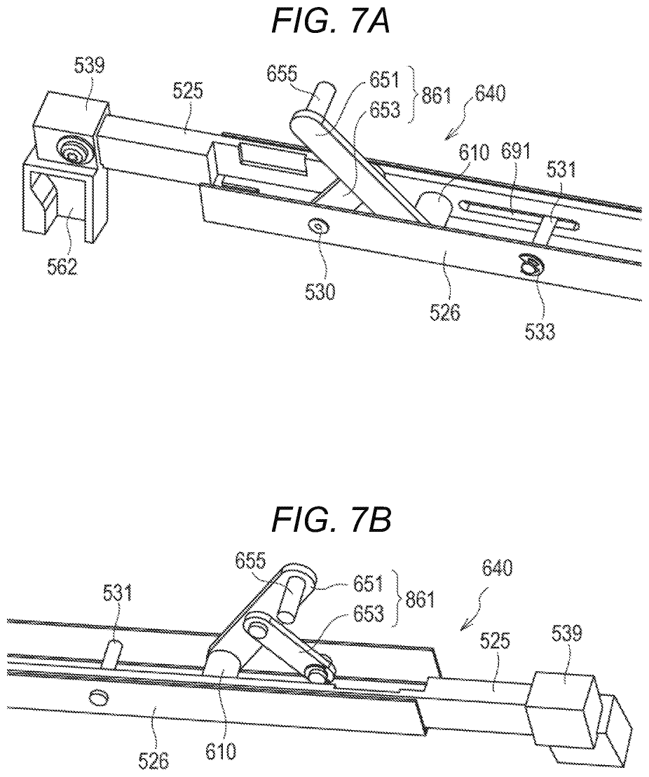

FIG. 7A is a schematic perspective view of the near side of the moving mechanism 640 as viewed from the left side. FIG. 7B is a schematic perspective view of the near side of the moving mechanism 640 as viewed from the right side.

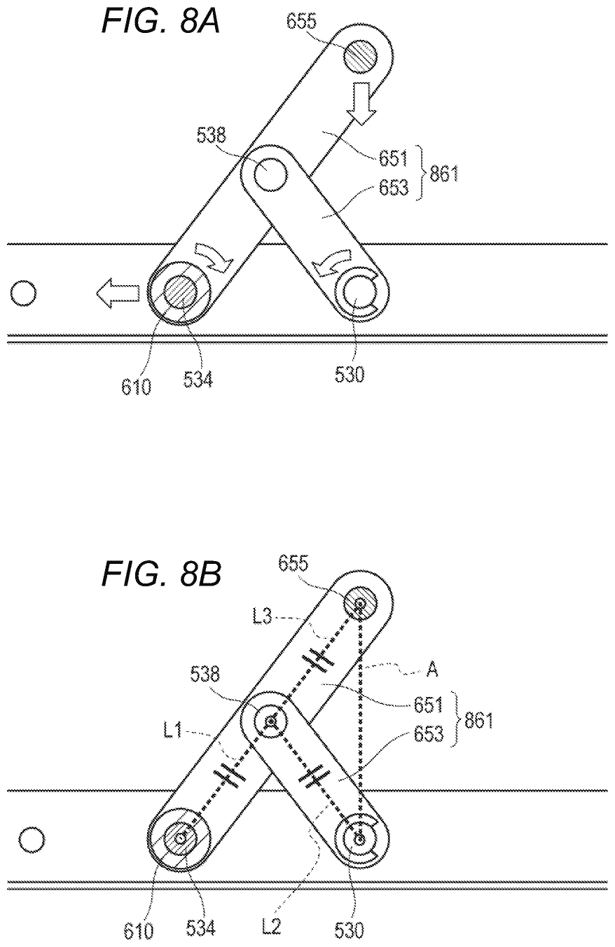

Hereinafter, the first link mechanism 861 will be described with reference to FIG. 7A, FIG. 7B, FIG. 8A and FIG. 8B. FIG. 8A is a cross-sectional view of the first link mechanism 861 taken along a plane along the rotary axis of the photosensitive drum 103 as viewed from the right side. The first link mechanism 861 includes the link member 651 and the link member 651 Each of the link member 651 and the link member 653, which form the first link mechanism 861, is a single link member. However, each of the link member 651 and the link member 653 may be formed by combining a plurality of link members. As illustrated in FIG. 8A and FIG. 8B, the length of the link member 653 in the longitudinal direction is shorter than the length of the link member 651 in the longitudinal direction.

The link member 651 includes a bearing portion 610, a protrusion 655 as one example of the pressing portion, and a connecting shaft portion 538. The link member 651 may be considered as one pressing portion as a whole. The bearing portion 610 is provided on one end side of the link member 651 in the longitudinal direction. The protrusion 655 is a columnar protrusion which is provided on the other end side of the link member 651 in the longitudinal direction, and which erects in the direction of the pivot axis of the link member 651. The protrusion 655 is a protrusion for deforming a spring provided to the holder 505 side of the optical print head 105. The connecting shaft portion 538 is provided between the bearing portion 610 and the protrusion 655 in the longitudinal direction of the link member 651. The first moving portion is not limited to the protrusion 655. The first moving portion may have a structure where one end side of the link member 651 in the longitudinal direction is bent in the direction of the pivot axis.

The bearing portion 610 has a circular hollow hole which extends in the left-right direction in FIG. 8A. A fitted shaft portion 534 is provided to the sliding portion 525. The fitted shaft portion 534 is a columnar protrusion which is erected in the leftward direction in FIG. 8A from the sliding portion 525. The fitted shaft portion 534 is pivotally fitted in a hole formed in the bearing portion 610, thus forming the first connecting portion. That is, the link member 651 is rotatable with respect to the sliding portion 525 using the first connecting portion as the center of pivot. It is also possible to adopt a configuration where the fitted shaft portion 534 is formed on the link member 651, and the bearing portion 610 is formed on the sliding portion 525.

The link member 653 includes a connecting shaft portion 530. The connecting shaft portion 530 is provided on one end side of the link member 653 in the longitudinal direction. The connecting shaft portion 530 is a columnar protrusion which is erected on the left side of the link member 653 as shown in FIG. 8A. The connecting shaft portion 530 is rotatably inserted into a hole formed in the first support portion 526, thus forming a third connecting portion. The connecting shaft portion 530 may not be formed on the link member 653, but may be formed on the first support portion 526. That is, the connecting shaft portion 530 formed on the third support portion may be inserted into a hole formed in the link member 653.

The other end side of the link member 653 in the longitudinal direction has a circular hole which extends in the left-right direction of the link member 653 as shown in FIG. 8A. The connecting shaft portion 538 of the link member 651 is pivotally inserted into the hole, and the connecting shaft portion 538 and the hole formed in the link member 653 form a fourth connecting portion. That is, the link member 653 is pivotable with respect to the first support portion 526 using the third connecting portion as the center of pivot. The link member 653 is pivotable with respect to the link member 651 using the fourth connecting portion as the center of pivot. The connecting shaft portion 538 may not be formed on the link member 651, but may be formed on the link member 653. That is, the connecting shaft portion 538 formed on the link member 653 may be inserted into a hole formed in the link member 651.

The configuration of the second link mechanism 862 is also equal to the above-described configuration of the first link mechanism 861. The link member 652 and the link member 654 which the second link mechanism 862 includes respectively correspond to the link member 651 and the link member 653. Accordingly, the members which form the link member 652 can be considered as one pressing portion as a whole. Further, a connecting portion between one end side of the link member 652 in the longitudinal direction and the sliding portion 525 forms a second connecting portion corresponding to the first connecting portion. The moving mechanism 640 may be configured such that either one of the link member 653 or the link member 654 is omitted.

With the above-mentioned configuration, when the sliding portion 525 slidably moves from the front side to the rear side with respect to the first support portion 526, the bearing portion 610 fitted to the fitted shaft portion 534 slidably moves from the front side to the rear side with respect to the first support portion 526 together with the sliding portion 525. With such movement, as illustrated. in FIG. 8A, when the first link mechanism 861 is viewed from the right side, the link member 651 pivots in the clockwise direction using the fitted shaft portion 534 as the center of pivot, and the link member 653 pivots in the counterclockwise direction using the connecting shaft portion 530 as the center of pivot. Accordingly, the protrusion 655 moves in a direction from the exposure position toward the retracted position.

On the other hand, when the sliding portion 525 slidably moves from the rear side to the front side with respect to the first support portion 526, the link member 651 and the link member 653 move in the directions opposite to directions indicated by arrows in FIG. 8A. When the sliding portion 525 slidably moves from the rear side to the front side with respect to the first support portion 526, the bearing portion 610 fitted to the fitted shaft portion 534 slidably moves from the rear side to the front side with respect to the first support portion 526 together with the sliding portion 525, With such movement, as illustrated. in FIG. 8A, when the first link mechanism 861 is viewed from the right side, the link member 651 pivots in the counterclockwise direction using the fitted shaft portion 534 as the center of pivot, and the link member 653 pivots in the clockwise direction using the connecting shaft portion 530 as the center of pivot. Accordingly, the protrusion 655 moves in a direction from the retracted position to the exposure position.

(1) A distance between the pivot center axis of the connecting shaft portion 538 and the pivot center axis of the bearing portion 610 is assumed as “L1”, (2) A distance between the pivot center axis of the connecting shaft portion 538 and the pivot center axis of the connecting shaft portion 530 is assumed as “L2”, (3) A distance between the pivot center axis of the connecting shaft portion 538 and the pivot center axis of the protrusion 655 is assumed as “L3”. In the moving mechanism 640, the first link mechanism 861 forms the Scott-Russell mechanism where the distances L1, L2 and L3 are equal to each other (see FIG, 8B). By setting the distances L1, L2 and L3 equal to each other, the protrusion 655 moves perpendicular to a direction along which the fitted shaft portion 534 slidably moves (the protrusion 655 moves on a dotted line A in FIG, 8B) and hence, the optical print head 105 can be moved by the above-mentioned link mechanism substantially in a direction of the optical axis of the lens.

It is also possible to adopt the following configuration. The first link mechanism 861 and the second link mechanism 862 are caused to have the structure opposite to the above-described structure in the front-rear direction. In such a case, when the sliding portion 525 is slidably moved from the front side to the rear side, the optical print head 105 moves from the retracted position toward the exposure position. On the other hand, when the sliding portion 525 is slidably moved from the rear side to the front side, the optical print head 105 moves from the exposure position toward the retracted position.

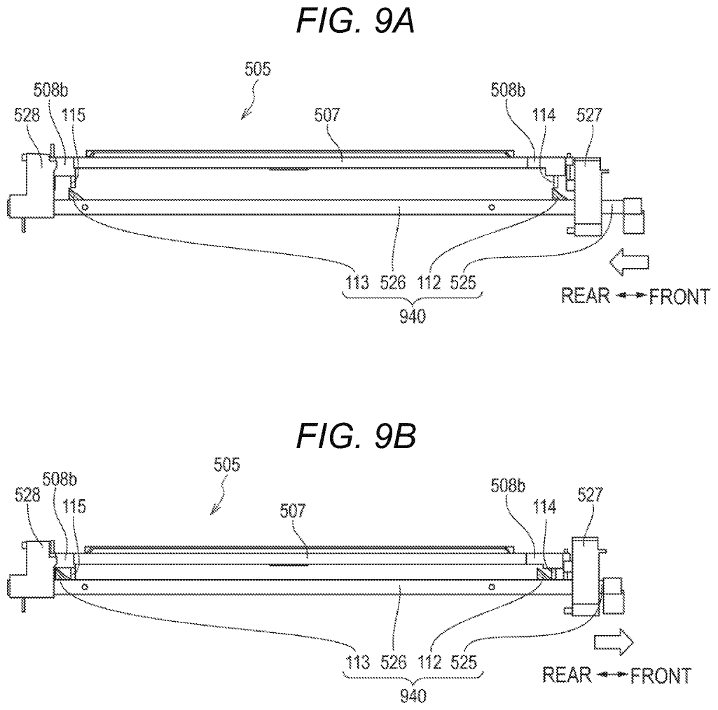

A mechanism which moves the optical print head 105 is not limited to the moving mechanism 640, and may be a moving mechanism 940 illustrated in FIG. 9A and FIG. 9B. Hereinafter, the structure of the moving mechanism 940 will be described with reference to FIG. 9A and FIG. 9B, Members of the moving mechanism 940 having substantially the same functions as the members forming the moving mechanism 640 are given the same reference characters, and the repeated description may be omitted.

As illustrated in FIG. 9A and FIG. 9B, a first cam portion 112 and a second cam portion 113 are provided to the front side and the rear side of the sliding portion 525. Further, a movement support portion 114 and a movement support portion 115 are provided to the lower front side of the holder 505 and the lower rear side of a holder 905. In the moving mechanism 940, the first cam portion 112 and the second cam portion 113 have a function as pressing portions.

The movement support portion 114 is a protrusion protruding from the pressed portion 508a toward the sliding portion 525. In this embodiment, the movement support portion 114 protrudes downwardly from the pressed portion 508a. In this embodiment, the pressed portion 508a and the movement support portion 114 are separate members. However, the pressed portion 508a and the movement support portion 114 may be integrally formed with each other.

The movement support portion 115 is a protrusion protruding from the pressed portion 508b toward the sliding portion 525. In this embodiment, the movement support portion 115 protrudes downwardly from the pressed portion 508b. In this embodiment, the pressed portion 508b and the movement support portion 115 are separate members. However, the pressed portion 508b and the movement support portion 115 may be integrally formed with each other.

Each of the first cam portion 112 and the second cam portion 113 has an inclined surface which is inclined from the rear side toward the front side in a direction that the inclined surface is away from the holder 505. The inclined surface of the first cam portion 112 supports the movement support portion 114, and the inclined surface of the second cam portion 113 supports the movement support portion 115.

FIG. 9A is a schematic view of the optical print head 105 and the moving mechanism 940 positioned at the exposure position as viewed from the right side. When the sliding portion 525 slidably moves from the front side toward the rear side with respect to the first support portion 526 with the optical print head 105 being at the exposure position, the first cam portion 112 and the second cam portion 113 provided to the sliding portion 525 slidably move from the front side toward the rear side with respect to the first support portion 526 together with the sliding portion 525. With such movement, lower ends of the movement support portion 114 and the movement support portion 115 provided to the holder 905 abut against the first cam portion 112 and the second cam portion 113. Accordingly, the movement support portion 114 and the movement support portion 115 move in a direction from the exposure position toward the retracted position along the first cam portion 112 and the second cam portion 113.

FIG. 9B is a schematic view of the optical print head 105 and the moving mechanism 940 positioned at the retracted position as viewed from the right side. When the sliding portion 525 slidably moves from the rear side to the front side with respect to the first support portion 526 with the optical print head 105 being at the retracted position, the first cam portion 112 and the second cam portion 113 provided to the sliding portion 525 slidably move from the rear side toward the front side with respect to the first support portion 526 together with the sliding portion 525. With such movement, the lower ends of the movement support portion 114 and the movement support portion 115 provided to the holder 905 are pushed and moved in the upward direction from the retracted position toward the exposure position along the first cam portion 112 and the second cam portion 113.

Each of the first cam portion 112 and the second cam portion 113 may have an inclined surface having a structure where the inclined direction of the inclined surface extends downwardly from the front side toward the rear side. In this case, when the sliding portion 525 is slidably moved from the front side to the rear side, the optical print head 105 moves from the retracted position toward the exposure position. When the sliding portion 525 is slidably moved from the rear side to the front side, the optical print head 105 moves from the exposure position toward the retracted position.

### Description of Force Which Acts on Optical Print Head Positioned at Exposure Position

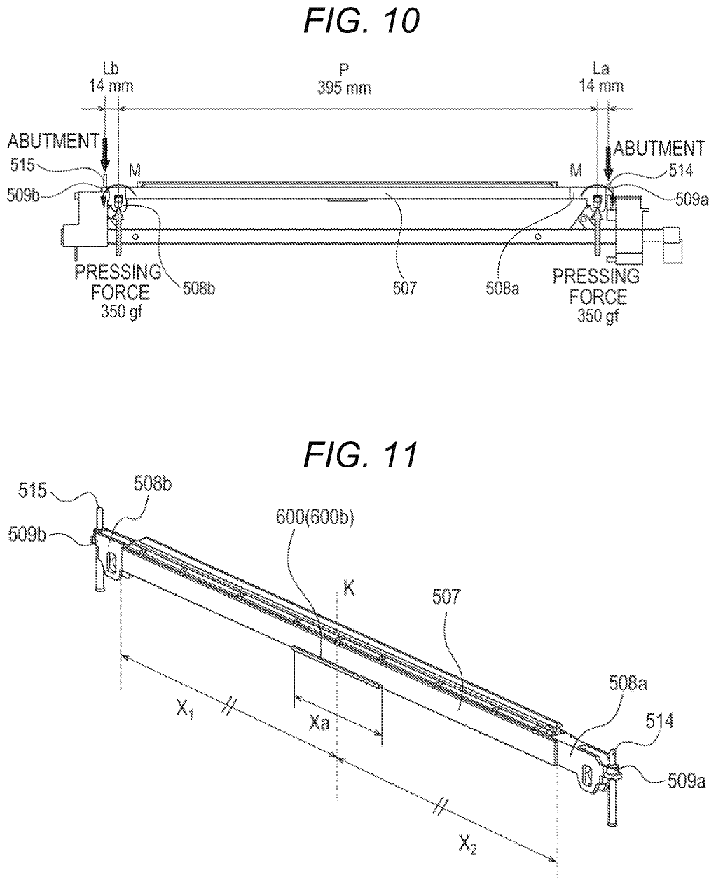

FIG. 10 is a view for describing a force which acts on the optical print head 105 positioned at the exposure position. The optical print head 105 illustrated in FIG. 10 is in a state where each of the abutment pin 514, provided on the near side of the optical print head 105, and the abutment pin 515, provided on the rear side of the optical print head 105, abuts against the drum unit 518. The abutment pin 514 and the abutment pin 515 abut against the drum unit 518, thus forming a gap between the optical print head 105 and the photosensitive drum 103. The position of the optical print head 105 in such a state is the exposure position.

As illustrated in FIG. 10, the abutment pin 514 is provided to the first mounting portion 509a, and the first mounting portion 509a is provided at a position closer to one end of the optical print head 105 than the first pressed portion 508a, pressed by the link member 651, in the longitudinal direction of the optical print head 105. In this embodiment, the first mounting portion 509a is disposed on the near side of the first pressed portion 508a. A portion where the abutment pin 514 and the drum unit 518 come into contact with each other (hereinafter also referred to as “first abutment point”) and a portion where the link member 651 presses a first pressed portion 509 (hereinafter also referred to as “first pressing point”) are displaced from each other in the main scanning direction (front-rear direction) by a distance La. The “main scanning direction” in this embodiment refers to a direction which is aligned with the longitudinal direction of the optical print head 105 and the direction of the rotary axis of the photosensitive drum 103. In this embodiment, the distance La is 14 mm.

As illustrated in FIG. 10, the abutment pin 515 is provided to the second mounting portion 509b, and the second mounting portion 509b is provided at a position closer to the other end of the optical print head 105 than the second pressed portion 508b, pressed by the link member 652, in the longitudinal direction of the optical print head 105. In this embodiment, the second mounting portion 509b is disposed on the far side of the second pressed portion 508b. A portion where the abutment pin 515 and the drum unit 518 come into contact with each other (second abutment point) and a portion where the link member 652 presses a second pressed portion 509 (second pressing point) are displaced from each other in the main scanning direction (front-rear direction) by a distance Lb. The “main scanning direction” in this embodiment refers to a direction which is aligned with the longitudinal direction of the optical print head 105 and the direction of the rotary axis of the photosensitive drum 103. In this embodiment, the distance Lb is 14 mm.

As illustrated in FIG. 10, the mounting portion 507 is disposed between the first pressed portion 508a and the second pressed portion 508b. In other words, in the longitudinal direction of the optical print head 105, the first pressed portion 508a is integrally formed with the mounting portion 507 on the near side of the mounting portion 507, and the second pressed portion 508b is integrally formed with the mounting portion 507 on the far side of the mounting portion 507. In this embodiment, a distance between the portion where the link member 651 presses the first pressed portion 508a (first pressing point) and the portion where the link member 652 presses the second pressed portion 508b (second pressing point) is 395 mm.

In this embodiment, between the abutment pin 514 and the abutment pin 515, the holder 505 is pressed toward the drum unit 518 by the link member 651 and the link member 652 with springs interposed therebetween. The link member 651, and the spring sandwiched between the link member 651 and the pressed portion 508a are also collectively referred to as “pressing portion”. In the same manner, the link member 652, and the spring sandwiched between the link member 652 and the pressed portion 508b are also collectively referred to as “pressing portion”.

The holder 505 is pressed toward the drum unit 518 by the link member 651 and the link member 652 in a state where both the abutment pin 514 and the abutment pin 515 abut against the drum unit 518. Accordingly, bending moments are generated in the holder 505 as indicated by arrows M in FIG. 10. Therefore, warping in the upward direction in FIG. 10 is generated in the holder 505. In other words, the optical print head 105 is pressed toward the drum unit 518 by the link member 651 and the link member 652 in a state where both the abutment pin 514 and the abutment pin 515 abut against the drum unit 518 and hence, a force in a direction along which the optical print head 105 is pressed is applied to the mounting portion 507.

### Description with Respect to Rib formed on Mounting Portion

FIG. 11 is a perspective view illustrating the optical print head 105 where the rib 600 is formed on the mounting portion 507. A dotted line K (intermediate line) in FIG. 11 indicates an intermediate portion between one end and the other end of the mounting portion 507 in the longitudinal direction of the optical print head 105. A distance X1 from the intermediate line K to the other end of the mounting portion 507 in the longitudinal direction of the optical print head 105 and a distance X2 from the intermediate line K to one end of the mounting portion 507 in the longitudinal direction of the optical print head 105 are equal to each other. That is, the intermediate line K is a line which bisects a line connecting one end and the other end of the mounting portion 507 in the longitudinal direction of the optical print head 105.

The rib 600 is formed to extend along the longitudinal direction of the optical print head 105 such that the rib 600 straddles the dotted line K in the longitudinal direction of the optical print head 105. The rib 600 is formed on the mounting portion 507 such that a portion of the rib 600 overlaps with the dotted line K and hence, warping of the optical print head 105 is suppressed.

In this embodiment, the rib 600 overlaps with the dotted line K, and is formed with a length of 20% of the length from one end to the other end of the optical print head 105 in the longitudinal direction of the optical print head 105. However, it is desirable to form the rib 600 over a range from one end to the other end of the mounting portion 507 in the longitudinal direction of the optical print head 105.

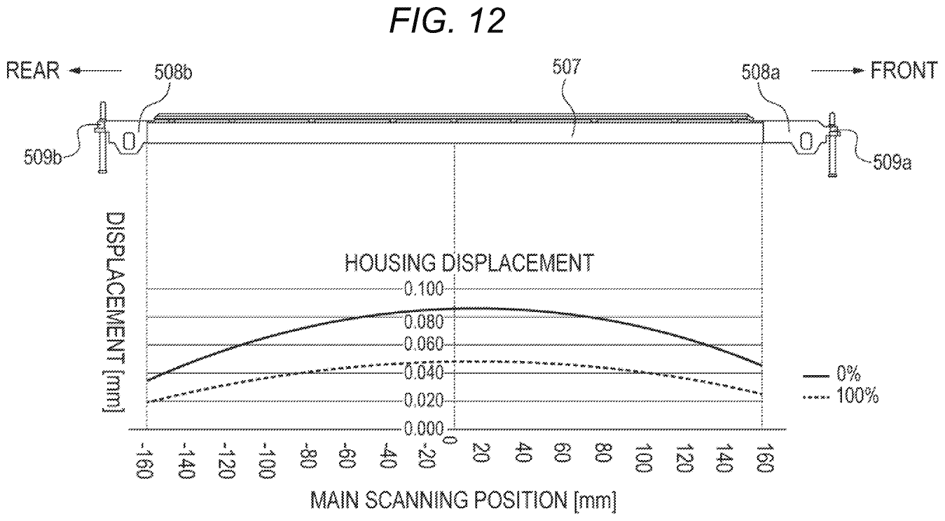

FIG. 12 illustrates the calculation results of the amount of deformation of the mounting portion 507 (the amount of displacement of the housing) over a range in the longitudinal direction of the optical print head 105 in the case where the optical print head 105 is positioned at the exposure position. In FIG. 12, coordinate axes are drawn assuming that the front side of the center of the mounting portion 507 in the longitudinal direction of the optical print head 105 has positive values, and the far (rear) side of the center of the mounting portion 507 in the longitudinal direction of the optical print head 105 has negative values. From this graph, the amount of deformation of the optical print head 105 at an arbitrary main scanning position can be understood. The calculated amount of deformation of the mounting portion 507 is the amount of deformation of the mounting portion 507 caused by the moving mechanism 640 (940) in a moving direction of the optical print head. Conditions of an analysis model used in the calculation of the amount of deformation of the mounting portion 507 are described below.

### Analysis Model Conditions

Distance P between first pressing point and second pressing point: 395 mm
Distance La between first abutment point and first pressing point: 14 mm
Distance Lb between second abutment point and second pressing point: 14 mm
Force at which link member 651 presses first pressed portion: 350 g force
Force at which link member 652 presses second pressed portion: 350 g force
Material for forming holder 505: LCP (Liquid Crystal Polymer)
Young's modulus of holder 505: 8.4×109 [Pa]
Thickness of holder 505: 1.5 mm
Protrusion amount of rib 600 from holder 505 (width of rib 600): 1.5 mm

FIG. 12 illustrates the calculation results of the amount of deformation of the mounting portion 507 over a range in the longitudinal direction of the optical print head 105. In the graph illustrated in FIG. 12, a curve indicated by a solid line indicates the amount of deformation of the mounting portion 507 having no rib 600, and a curve indicated by a dotted line indicates the amount of deformation of the mounting portion 507 having the rib 600.

As illustrated in FIG. 12, in the case of the mounting portion 507 having no rib 600, the mounting portion 507 is deformed by 86 μm at maximum under the above-mentioned analysis model conditions. On the other hand, in the case where the rib 600 is formed in a range from one end to the other end of the mounting portion 507 in the longitudinal direction of the optical print head 105, the maximum amount of deformation of the mounting portion 507 can be reduced to 47 μm under the above-mentioned analysis model conditions.

The rib 600 is a protrusion protruding from the surface of the mounting portion 507 on one side and the surface of the mounting portion 507 on the other side in a perpendicular direction which is perpendicular to both of the moving direction of the optical print head 105 and the longitudinal direction of the optical print head 105. The rib 600 is formed on the mounting portion 507 such that the rib 600 straddles the intermediate line K between one end and the other end of the mounting portion 507 in the longitudinal direction of the optical print head 105. The rib 600 is formed on the mounting portion 507 such that the rib 600 straddles the intermediate line K in the longitudinal direction of the optical print head 105, and the rib 600 extends in the longitudinal direction of the optical print head 105.

As described above, the rib 600 is formed such that the rib 600 straddles the intermediate line K which bisects the mounting portion 507 in the longitudinal direction of the optical print head 105. Accordingly, the amount of deformation of the mounting portion 507 can be reduced.

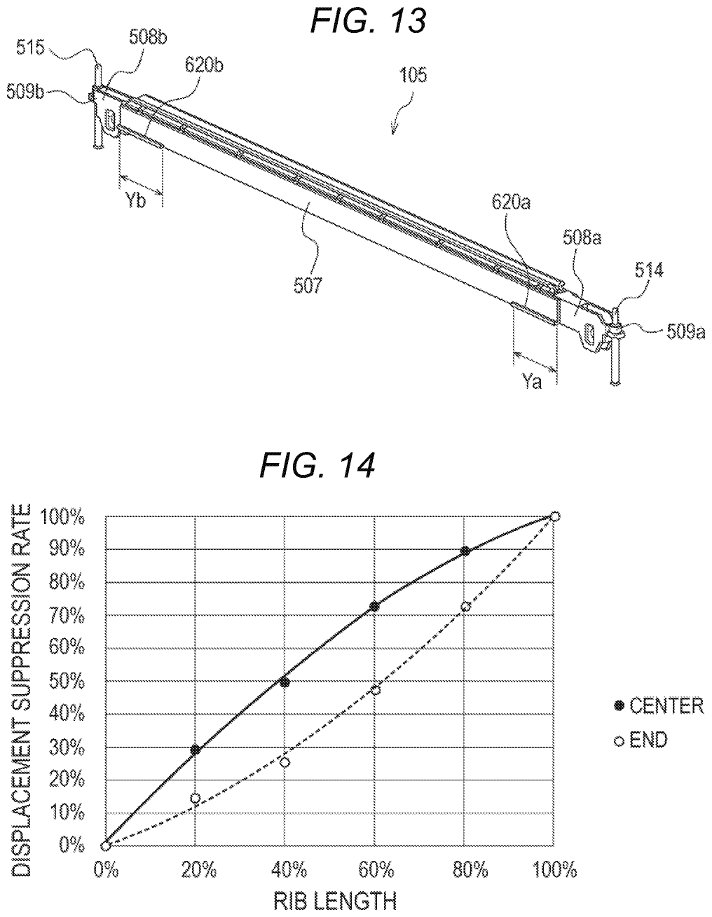

FIG. 13 is a schematic perspective view of the optical print head 105 where a rib 620a (one example of a first protruding portion) is formed on one end side of the mounting portion 507 in the longitudinal direction of the optical print head 105, and a rib 620b (one example of a second protruding portion) is formed on the other end side of the mounting portion 507 in the longitudinal direction of the optical print head 105. The rib 620a and the rib 620b may be formed only on one side of the mounting portion 507 or may be formed only on the other side of the mounting portion 507 in a perpendicular direction which is perpendicular to both of the longitudinal direction of the optical print head 105 and the moving direction of the optical print head 105 along which the optical print head 105 is moved by the moving mechanism 640. As a matter of course, the rib 620a and the rib 620b may be formed on both of one side and the other side of the mounting portion 507 in a perpendicular direction which is perpendicular to both of the longitudinal direction of the optical print head 105 and the moving direction of the optical print head 105 along which the optical print head 105 is moved by the moving mechanism 640. A bending moment which causes deformation of the mounting portion 507 is discussed. Portions which correspond to the fulcrums of the bending moments are a portion where the abutment pin 514 and the drum unit 518 abut against each other and a portion between the abutment pin 515 and the drum unit 518 abut against each other. Further, portions which correspond to force points are a portion where the link member 651 presses the first pressed portion 508a and a portion where the link member 652 presses the second pressed portion 508b. Accordingly, portions of the mounting portion 507 which are close to the fulcrums and the force points are reinforced by the rib 620a and the rib 620b. With such reinforcement, it is possible to suppress the amount of deformation of the optical print head 105 which is caused by the above-mentioned bending moments.

A plot indicated by black dots in the graph illustrated in FIG. 14 illustrates a displacement suppression rate of the mounting portion 507 in the case where the ratio of the length of the rib 600 with respect to the total length of the mounting portion 507 in the longitudinal direction of the optical print head 105 is changed at 20% intervals. The displacement suppression rate will be described. It is assumed that a maximum deformation suppression amount is the amount of deformation of the mounting portion 507 which can be suppressed by forming, on the mounting portion 507, the rib 600 having a length of 100% of the total length of the mounting portion 507 in the longitudinal direction of the optical print head 105 with respect to the amount of deformation by which the mounting portion 507 having no rib is deformed with the optical print head 105 being positioned at the exposure position. The deformation suppression rate (also referred to as “displacement suppression rate”) refers to a ratio of the amount by which the deformation of the mounting portion 507 can be actually suppressed with respect to this maximum deformation suppression amount.

For example, as described previously with reference to FIG. 12, in the case of the mounting portion 507 having no rib 600, the mounting portion 507 is deformed by at maximum when the optical print head 105 is positioned at the exposure position. Assume the case where the rib 600 is formed on the mounting portion 507, and the rib 600 has a length of 100% of the total length of the mounting portion 507 in the longitudinal direction of the optical print head 105. In such a case, the maximum amount of deformation of the mounting portion 507 is 47 μm. Accordingly, the maximum deformation suppression amount is 39 μm, which is a difference between 86 μm and 47 μm. The graph in FIG. 14 is referenced. For example, in the case where the deformation suppression rate is 30%, the amount by which the deformation of the mounting portion 507 can be suppressed is 30% of 39 μm, that is, approximately 12 μm.

According to the experiment of the inventor, the notable advantageous effect of suppressing the amount of deformation of the mounting portion 507 can be obtained by setting the ratio of the length of the rib 600 with respect to the total length of the mounting portion 507 in the longitudinal direction of the optical print head 105 to 15% or more. The advantageous effect of suppressing the amount of deformation of the mounting portion 507 can be obtained irrespective of the length of the rib 600 by forming the rib 600 on the mounting portion 507 so as to straddle the intermediate line K.
In FIG. 14, the curve indicated by a solid line is an approximate curve of a plot indicated by black dots. In the same manner, in FIG. 14, the curve indicated by a dotted line is an approximate curve of a plot indicated by white dots. The plot indicated by the white dots is a plot illustrating the amount of deformation of the mounting portion 507 when the ratio of the length of the rib 620a and the rib 620b is changed at 20% intervals with respect to the total length of the mounting portion 507 in the longitudinal direction of the optical print head 105. In the plot indicated by the white dots, the ribs labeled “20%”, for example, indicate that each of the rib 620a and the rib 620b is a rib having a length of 10% of the total length of the mounting portion 507 in the longitudinal direction of the optical print head 105. That is, in this embodiment, the total length of the mounting portion 507 in the longitudinal direction of the optical print head 105 is 380 mm and hence, each of the rib 620a and the rib 620b is a rib with a length of 38 mm in this embodiment. In the same manner, in the case of ribs labeled “40%”, for example, each of the rib 620a and the rib 620b is a rib having a length of 76 mm.
According to the experiment of the inventor, the notable advantageous effect of suppressing the amount of deformation of the mounting portion 507 can be obtained by setting the ratio of the length of the rib 620a and the rib 620b with respect to the total length of the mounting portion 507 in the longitudinal direction of the optical print head 105 to 15% or more. The advantageous effect of suppressing the amount of deformation of the mounting portion 507 can be obtained irrespective of the length of the rib 620a and the rib 620b by forming the rib 620a and the rib 620b on the mounting portion 507 so as to straddle the intermediate tine K.

From the calculation results illustrated in FIG. 14, the following can be understood. Assume a case where, different from the rib 600, the rib is not formed on the mounting portion 507 so as to straddle the intermediate line K. Even in such a case, by forming the rib 620a on one end side of the mounting portion 507 and by forming the rib 620b on the other end side of the mounting portion 507 in the longitudinal direction of the optical print head 105, it is possible to suppress the amount of deformation of the mounting portion 507 which is caused when the optical print head 105 is positioned at the exposure position.

The holder 505 may also be deflected by a dead weight. The rib 600, the rib 620a and the rib 620b also have an advantageous effect of suppressing warping of the holder 505 which is caused by the dead weight of the optical print head 105 per se.

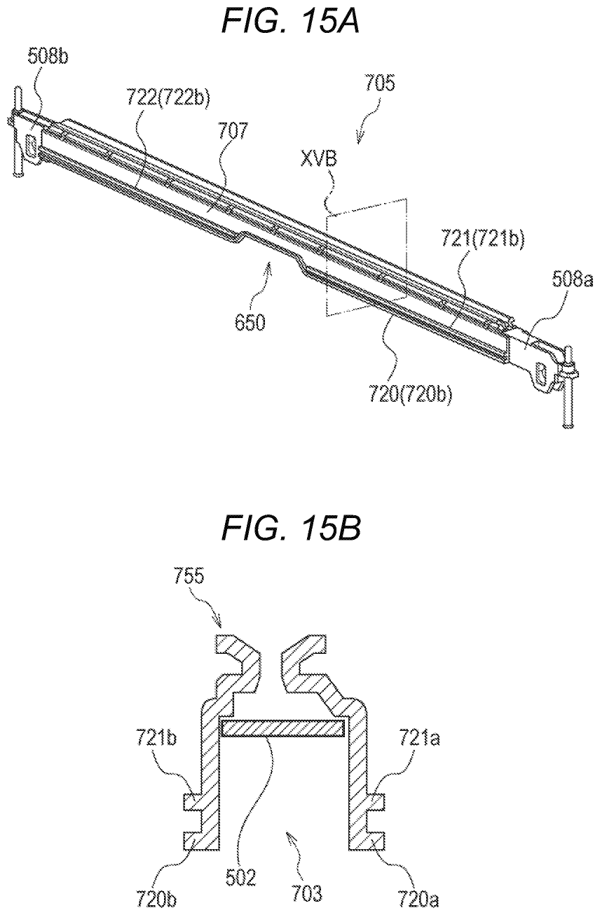

FIG. 15A is a schematic perspective view of the optical print head 705 which is formed by arranging a rib 721, a rib 722 and a rib 720 in the moving direction of an optical print head 705. FIG. 15B is a cross-sectional view of the optical print head 705 at a portion indicted by a region XVB in FIG. 15A. As illustrated in FIG. 15B, a rib 720a (720b) and a rib 721a (rib 721b) are formed by arranging in the moving direction of the optical print head 705, thus increasing rigidity of a mounting portion 707. The rib 720a (720b) and the rib 721a (rib 721b) are formed in a row in a spaced apart manner in the up-down direction.

The mounting portion 707 of the optical print head 705 illustrated in FIG. 15A has a cut-away portion 650. The connector of the circuit board 502, which is accommodated in the mounting portion 707, is exposed from the cut-away portion 650. A flexible flat cable (FFC) (not illustrated in the drawing) is connected to the connector, and transmits an electric signal to the circuit board 502. The connector of the circuit board 502 is exposed from the cut-away portion 650, thus allowing an operator, such as a service person, to easily mount and remove an FFC on and from the connector of the circuit board 502.

As illustrated in FIG. 15A and FIG. 15B, the rib 720 is formed on the mounting portion 707 such that the rib 720 extends along the longitudinal direction of the optical print head 705 at the end portion of a holder 755 on the opening 703 side. The rib 721 is formed on the mounting portion 707 at a position on the near side of the cut-away portion 650 and on the mounting portion 707 at a position on the far side of the cut-away portion 650. As described above, a region where the rib 720 and the rib 721 are formed in a plurality of rows in the moving direction of the optical print head 705 and a region where the rib 720 and the rib 722 are formed in a plurality of rows in the moving direction of the optical print head 705 are formed on the mounting portion 707. With such a configuration, rigidity of the mounting portion 707 can be increased.

In this embodiment, the thickness of each of the rib 720 and the rib 721 (the rib 722) in the up-down direction is 1 mm. Further, a distance between the rib 720 and the rib 721 (the rib 722) is 1.5 mm. To further increase rigidity of the mounting portion 707, it is preferable to set a distance between the rib 720 and the rib 721 (the rib 722) to a smaller value. It is preferable to set the distance between the rib 720 and the rib 721 (the rib 722) to a value equal to or less than a value three times larger than the thickness of the rib 720 or the rib 721 (the rib 722) whichever has a larger thickness in up-down direction. Specifically, when the thickness of the rib 720 in the up-down direction is 1 mm, and the thickness of the rib 721 (the rib 722) in the up-down direction is 1 mm, it is preferable to set a distance between the rib 720 and the rib 721 (the rib 722) to 3 mm or less.

While the present disclosure has been described with reference to example embodiments, it is to be understood that the disclosure is not limited to the disclosed example embodiments. The scope of the following claims is to be accorded the broadest interpretation so as to encompass all such modifications and equivalent structures and functions.

This application claims the benefit of Japanese Patent Application No. 2018-194551, filed Oct. 15, 2018, which is hereby incorporated by reference herein in its entirety.

What is claimed is:

1. A print head which is provided to an image forming apparatus including a drum unit having a photosensitive drum, the print head comprising:
a circuit board including light emitting elements which emit light for exposing the photosensitive drum;
a lens array configured to cause the light emitted from the light emitting elements to be focused on the photosensitive drum; and
a holder including the circuit board and the lens array, and made of a resin, the holder including:
a mounting portion on which the circuit board is mounted;
a first pressed portion and a second pressed portion with which a pressing portion comes into contact, the pressing portion pressing the print head toward the drum unit, thus moving the print head toward the drum unit, wherein the first pressed portion is provided to the mounting portion at a position on one side of the mounting portion in a longitudinal direction of the print head, and the second pressed portion is provided to the mounting portion at a position on the other side of the mounting portion in the longitudinal direction;
a first positioning portion and a second positioning portion for positioning the print head, which is pressed and moved by the pressing portion, at a position for exposing the photosensitive drum, the first positioning portion being provided to the first pressed portion at a position on an upstream side of the first pressed portion in one direction from the first pressed portion toward the second pressed portion, and abutting against the drum unit, and the second positioning portion being provided to the second pressed portion at a position on a downstream side of the second pressed portion in the one direction, and abutting against the drum unit;
a first side wall portion which opposes one side of the circuit board in a perpendicular direction which is perpendicular to both of the longitudinal direction and a moving direction of the print head;
a second side wall portion which opposes the other side of the circuit board in the perpendicular direction; and
a protruding portion which protrudes from at least either one of a surface of the first side wall portion on a side opposite to a surface of the first side watt portion which opposes the circuit board in the perpendicular direction and a surface of the second side wall portion on a side opposite to a surface of the second side wall portion which opposes the circuit board in the perpendicular direction, the protruding portion extending in the longitudinal direction while straddling a line bisecting the mounting portion in the longitudinal direction.

2. The print head according to claim 1, wherein the protruding portion is formed on each of the surface of the first side wall portion on the side opposite to the surface of the first side wall portion which opposes the circuit board in the perpendicular direction and the surface of the second side wall portion on the side opposite to the surface of the second side wall portion which opposes the circuit board in the perpendicular direction.

3. The print head according to claim 1, wherein a width of the protruding portion in the perpendicular direction is equal to or greater than either one of a width of the first side wall portion in the perpendicular direction or a width of the second side wall portion in the perpendicular direction.

4. The print head according to claim 1, wherein a length of the protruding portion in the longitudinal direction is 15% or more of a distance between end portions of the mounting portion in the longitudinal direction.

5. A print head which is provided to an image forming apparatus including a drum unit having a photosensitive drum, the print head comprising:
a circuit board including light emitting elements which emit light for exposing the photosensitive drum;
a lens array configured to cause the light emitted from the light emitting elements to be focused on the photosensitive drum; and
a holder including the circuit board and the lens array, and made of a resin, the holder including:
a mounting portion on which the circuit board is mounted;
a first pressed portion and a second pressed portion with which a pressing portion comes into contact, the pressing portion pressing the print head toward the drum unit, thus moving the print head toward the drum unit, wherein the first pressed portion is provided to the mounting portion at a position on one side of the mounting portion in a longitudinal direction of the print head, and the second pressed portion is provided to the mounting portion at a position on the other side of the mounting portion in the longitudinal direction;
a first positioning portion and a second positioning portion for positioning the print head, which is pressed and moved by the pressing portion, at a position for exposing the photosensitive drum, the first positioning portion being provided to the first pressed portion at a position on an upstream side of the first pressed portion in one direction from the first pressed portion toward the second pressed portion, and abutting against the drum unit, and the second positioning portion being provided to the second pressed portion at a position on a downstream side of the second pressed portion in the one direction, and abutting against the drum unit;
a first side wall portion which opposes one side of the circuit board in a perpendicular direction which is perpendicular to both of the longitudinal direction and a moving direction of the print head;
a second side wall portion which opposes the other side of the circuit board in the perpendicular direction; and
a first protruding portion and a second protruding portion which protrude from at least either one of a surface of the first side wall portion on a side opposite to a surface of the first side wall portion which opposes the circuit board in the perpendicular direction and a surface of the second side wall portion on a side opposite to a surface of the second side wall portion which opposes the circuit board in the perpendicular direction,
wherein the first protruding portion extends in the longitudinal direction on one end side of the mounting portion in the longitudinal direction, and the second protruding portion extends in the longitudinal direction on the other end side of the mounting portion in the longitudinal direction.

6. The print head according to claim 5, wherein the first protruding portion is formed on each of the surface of the first side wall portion on the side opposite to the surface of the first side wall portion which opposes the circuit board in the perpendicular direction and the surface of the second side wall portion on the side opposite to the surface of the second side wall portion which opposes the circuit board in the perpendicular direction.

7. The print head according to claim 5, wherein the second protruding portion is formed on each of the surface of the first side watt portion on the side opposite to the surface of the first side wall portion which opposes the circuit board in the perpendicular direction and the surface of the second side wall portion on the side opposite to the surface of the second side wall portion which opposes the circuit board in the perpendicular direction.

8. The print head according to claim 5, wherein a width of the first protruding portion in the perpendicular direction and a width of the second protruding portion in the perpendicular direction arc equal to or greater than either one of a width of the first side wall portion in the perpendicular direction or a width of the second side wall portion in the perpendicular direction.

9. The print head according to claim 5, wherein a length of the first protruding portion in the longitudinal direction and a length of the second protruding portion in the longitudinal direction are 15% or more of a distance between end portions of the mounting portion in the longitudinal direction.

10. The print head according to claim 5, wherein the mounting portion includes a third protruding portion which protrudes from at least either one of the surface of the first side wall portion on the side opposite to the surface of the first side wall portion which opposes the circuit board and the surface of the second side wall portion on the side opposite to the surface of the second side wall portion which opposes the circuit board, the third protruding portion extending in the longitudinal direction, and wherein the third protruding portion is formed on the mounting portion such that the third protruding portion and at least either one of the first protruding portion or the second protruding portion are arranged side by side at an interval from each other in the moving direction of the print head which is moved by being pressed by the pressing portion.

11. The print head according to claim 1, wherein the light emitting elements are LEDs.

12. The print head according to claim 1, wherein the tight emitting elements are OLEDs.

13. An image forming apparatus comprising:
a photosensitive drum;
a drum unit including the photosensitive drum;
a print head including:
a circuit board including light emitting elements which emit light for exposing the photosensitive drum;
a lens array configured to cause the light emitted from the light emitting elements to be focused on the photosensitive drum; and
a holder including the circuit board and the lens array, and made of a resin, the holder including:
a mounting portion on which the circuit board is mounted;
a first pressed portion and a second pressed portion with which a pressing portion comes into contact, the pressing portion pressing the print head toward the drum unit, thus moving the print head toward the drum unit, wherein the first pressed portion is provided to the mounting portion at a position on one side of the mounting portion in a longitudinal direction of the print head, and the second pressed portion is provided to the mounting portion at a position on the other side of the mounting portion in the longitudinal direction;
a first positioning portion and a second positioning portion for positioning the print head, which is pressed and moved by the pressing portion, at a position for exposing the photosensitive drum, the first positioning portion being provided to the first pressed portion at a position on an upstream side of the first pressed portion in one direction from the first pressed portion toward the second pressed portion, and abutting against the drum unit, and the second positioning portion being provided to the second pressed portion at a position on a downstream side of the second pressed portion in the one direction, and abutting against the drum unit;
a first side wall portion which opposes one side of the circuit board in a perpendicular direction which is perpendicular to both of the longitudinal direction and a moving direction of the print head;
a second side wall portion which opposes the other side of the circuit board in the perpendicular direction; and
a protruding portion which protrudes from at least either one of a surface of the first side wall portion on a side opposite to a surface of the first side wall portion which opposes the circuit board in the perpendicular direction and a surface of the second side wall portion on a side opposite to a surface of the second side watt portion which opposes the circuit board in the perpendicular direction, the protruding portion extending in the longitudinal direction while straddling a line bisecting the mounting portion in the longitudinal direction;
a developing unit which develops, using toner, an electrostatic latent image formed on the photosensitive drum by the print head, thus forming a toner image on the photosensitive drum; and
a transfer unit which transfers the toner image formed by the developing unit onto a recording medium.
